(19) United States
(12) Patent Application Publication
(10) Pub. No.: US 2014/0173746 A1
(43) Pub. Date: Jun. 19, 2014

(54) APPLICATION REPOSITORY

(71) Applicant: APPLE INC., Cupertino, CA (US)

(72) Inventors: Joel S. ARMSTRONG-MUNTNER, San Mateo, CA (US); James J. DUDLEY, Sunnyvale, CA (US)

(73) Assignee: Apple Inc., Cupertino, CA (US)

(21) Appl. No.: 13/713,422

(22) Filed: Dec. 13, 2012

(51) Int. Cl. G06F 21/62

(52) U.S. Cl. CPC G06F 21/62
USPC 726/27

(57) ABSTRACT

Methods of providing an application repository based on an age level of a user to create an age-appropriate experience for younger users of an electronic device are disclosed. Certain applications can be associated with the application repository. The content of any application associated with the repository can then be based on the associated age level. For example, if an educational application is associated with an application repository, then the educational elements of the application can be targeted to the specific age level associated with the repository.

### FIELD OF THE DISCLOSURE

This relates generally to managing access to applications on an electronic device.

### BACKGROUND OF THE DISCLOSURE

Educational and recreational software directed to children is becoming increasingly popular on mobile devices, including mobile phones and tablets. However, a child or other user with unrestricted access to such a device might access inappropriate content or use the device in an inappropriate way, such as by placing a call or deleting software.

### SUMMARY OF THE DISCLOSURE

This relates to methods of providing an application repository based on an age level of a user to create an age-appropriate experience for younger users of an electronic device. Certain applications can be associated with the application repository. The content of any application associated with the repository can then be based on the associated age level. For example, if an educational application is associated with an application repository, then the educational elements of the application can be targeted to the specific age level associated with the repository.

### BRIEF DESCRIPTION OF THE DRAWINGS

FIG. 1 illustrates an exemplary association of applications to repositories according to examples of the disclosure.

FIG. 2 illustrates an exemplary method of creating and using an application repository according to examples of the disclosure.

FIG. 3 is a block diagram illustrating an exemplary API architecture, which may be used in some examples of the disclosure.

FIG. 4 illustrates an exemplary software stack of an API according to examples of the disclosure.

FIG. 5 is a block diagram illustrating exemplary interactions between the touch screen and the other components of the device according to examples of the disclosure.

FIG. 6 is a block diagram illustrating an example of a system architecture that may be embodied within any portable or non-portable device according to examples of the disclosure.

FIG. 7 illustrates an exemplary method of enabling applications during a session associated with an application repository according to examples of the disclosure.

### DETAILED DESCRIPTION

In the following description of examples, reference is made to the accompanying drawings which form a part hereof, and in which it is shown by way of illustration specific examples that can be practiced. It is to be understood that other examples can be used and structural changes can be made without departing from the scope of the disclosed examples.

Various examples are related to methods of providing an application repository based on an age level of a user to create an age-appropriate experience for younger users of an electronic device. Certain applications can be associated with the application repository. The content of any application associated with the repository can then be based on the associated age level. For example, if an educational application is associated with an application repository, then the educational elements of the application can be targeted to the specific age level associated with the repository.

Although examples disclosed herein may be described and illustrated herein primarily in terms of managing access for children, it should be understood that the examples are not so limited, but are additionally applicable to methods of managing access and starting limited access sessions generally.

In some examples, a limited access mode can be enabled on an electronic device, wherein only applications associated with an application repository may be accessed by a user of the device. For example, the limited access mode could be tailored for children, limiting access to applications that might be age-inappropriate.

The limited access mode may be enabled based on user input associated with the limited access mode. For example, an icon may be associated with the mode and user input on the icon can enable the mode. In other examples, the limited access mode may be enabled based on gesture or voice input, among other types of user input. Similarly, the limited access mode may be disabled based on user input. Disabling the limited access mode may be made less intuitive than enabling the limited access mode. For example, enabling the limited access mode may be as simple as selecting an icon, whereas disabling the limited access mode may require input of a multitouch gesture. In some examples, disabling the limited access mode may be based on a pitch of a user voice. For example, the limited access mode may be disabled based on the low pitch of an adult voice, such that only adults would be able to disable the limited access mode.

In some examples, the limited access mode may limit user access of applications to those associated with an application repository. Accordingly, only icons of those applications may be displayed in a menu of available applications or on a desktop associated with the limited access mode. In some examples, a user may attempt to access an application not associated with the application repository and then be denied access to the application. Additionally, functionality of the device may be limited by the limited access mode. For example, only certain contacts associated with the limited access mode may be messaged in a messaging application or dialed in a phone application.

An application repository can be created and associated with an age level of a user. For example, an application repository may be associated with an age level of 5 years and younger, 6 years to 9 years, or 10 years to 14 years, among other possibilities. Additionally, multiple repositories may be associated with the same age level. Additionally or alternatively to an age level, an application repository may be associated with an ability level or a grade level, any of which may be determined in terms of ages or grades, in some examples.

When an application repository is created, additional information may be associated with the repository, such as a name of the user and a gender of a user, among other possibilities. The information may be separate from other identifying information of the device. For example, an iPhone may be associated with a single Apple ID, but one or more application repositories on the iPhone may each be associated with a different user and information of that user, including age level. In other examples not necessarily associated with a user's age, application repositories may be created for specific individuals, so that individuals can have private access to certain applications. In other examples, application repositories can be created based on gender, family relationship (e.g., the two parents or responsible caregivers as opposed to the children in the family), group affiliation (club, business, or other organization), title within an organization (e.g., a shared law firm tablet computer may have different application repositories for partners, associates and staff), or a combination of one or more of these.

A user can associate one or more applications with an application repository. In some examples, a user can drag application icons and drop the icons on an icon for an application repository to associate the applications with the application repository. A single application may be associated with more than one application repository.

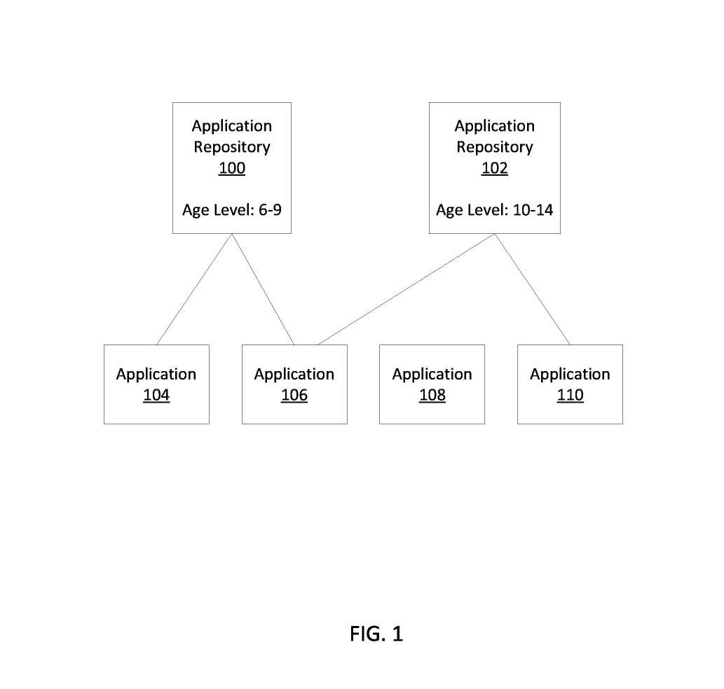

FIG. 1 illustrates an exemplary association of applications to repositories according to examples of the disclosure. Application repository 100 can be associated with an age level of 6 years to 9 years, whereas application repository 102 can be associated with an age level of 10 years to 14 years. Applications 104 and 106 can be associated with application repository 100, and applications 106 and 110 can be associated with application repository 102. Application 106 is illustrated as associated with both application repositories 100 and 102, and thus application 106 can be accessible in a limited access mode associated with either repository 100 or 102. Additionally, application 108 is illustrated as being unassociated with any application repository, and thus application 108 can be inaccessible in any limited access mode.

In some examples, the limited access mode can change the functionality of one or more applications associated with the application repository. For example, if a limited access mode is disabled, an application may use general identifying information associated with the device. However, if the limited access mode is enabled, then the application may use identifying information associated with the application repository. Additionally, in a limited access mode, the use of certain identifying information such as gender, age, and address may be restricted to protect younger users. In another example, certain features of applications such as chatting or making purchases may be disabled in the limited access mode.

In some examples, content of an application may be modified in the limited access mode based on information associated with the application repository, such as age level. For example, in an educational application, an appropriate math problem may be selected based on the age level associated with the application repository. In another example, a difficulty level of a game may be selected based on the age level associated with the application repository.

In some examples, the user may be prompted to engage in activities based on an age level of the user. Activity prompts can appear at regular time intervals. Such prompts can be used to occasionally interrupt recreational application use with educational activities, for example. The activity prompts may be related to the application currently in use. For example, a story application that uses the word “apple” may be interrupted with a prompt that asks the user to spell the word “apple.” Additionally, an API can be provided to allow application developers to call for prompts within applications. For example, a game application can call for an educational activity prompt between levels of the game. The game application itself need not define a specific educational activity or age level, but by calling the API method, the application can call an API-implementing component that provides an educational activity prompt appropriate to the age level of the user. In some examples, the prompt may be a visual prompt displayed on the device. For example, a dialog box may pop up on the display as a visual prompt. In some examples, the prompt may be an auditory prompt. For example, in devices with a voice assistant, such as Siri® for iPhone, the voice assistant may deliver an auditory prompt to the user.

In some examples, a schedule can be created to manage access to applications associated with an application repository. For example, certain recreational applications may only be accessible during a set period of time every day, whereas other educational applications may always be available. Different schedules can be set for different days. For example, a weekday schedule may differ from a weekend schedule, and a holiday schedule may also be created. In some examples, there may be a time limit on applications. For example, certain recreational applications may only be available for 60 minutes every day. After 60 minutes of application usage has been logged in a day, whether the usage is continuous or not, access to those applications may be disabled.

In some examples, access to restricted applications may be provided as a reward for completing tasks in one or more accessible applications. For example, if access to a recreational application has been restricted because it is outside a set period of time for recreational applications or because the application is not associated with an application repository, then a user may be granted access to the recreational application based on the completion of a certain number of math problems in a math application, among other possibilities.

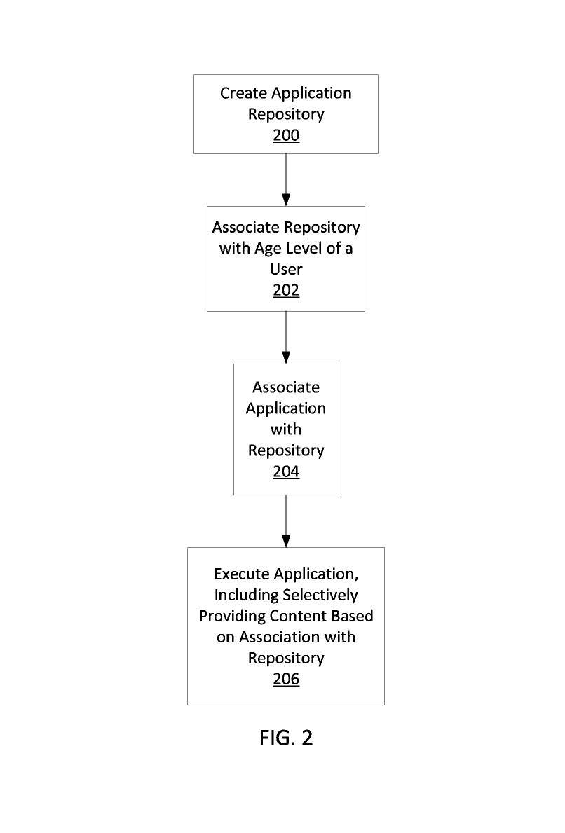

FIG. 2 illustrates an exemplary method of creating and using an application repository according to examples of the disclosure. An application repository can be created (200) in response to user input of an electronic device. For example, a user can select a menu item through touch input or a mouse to create an application repository. The application repository can be associated with an age level of a user (202), or other criteria discussed above. If associated with an age level, the repository can be associated with a default age level in some examples, or the age level can be chosen by a user. In some examples, the user can choose from a predefined list of age levels. An application can be associated with the application repository (204). As discussed above, applications can be associated with a repository by drag and drop user input, among other possibilities. The application can be executed, and executing the application can include selectively providing content based on the association with the application repository (206). As discussed above, selectively providing content can include modifying the content based on the age level or other criteria of the associated application repository. In some examples, selectively providing content can include providing additional content based on an age level or other criteria, such as providing an activity prompt based on an age level.

In some examples, the execution of the application may be based on a schedule associated with the application and/or the application repository. A time may be compared to the schedule, and access to the application may be granted or denied based on the comparison.

In some examples, the execution of the application may include granting, based on user input to the application, access to an additional application. For example, as discussed above, access to a restricted application may be provided as a reward for completing tasks in one or more accessible applications.

In some examples, applications in an application repository may be used in a session associated with the application repository. This and other examples may not be limited to situations where the repository is associated with an age/grade/ability level. Enabling use of only certain applications during a session may be useful in a situation where a device is being used by someone other than a primary user or for some specific purpose. Additionally, the session can provide additional features upon the termination of the session, such as creating a summary of the activity during the session and emailing the summary to the session user.

For example, in a retail setting a floor model of a tablet could start a new session when a customer begins to use the device. The customer may use any applications associated with a repository for the session, such as a camera application and a music creation application. When the session is ended, some or all of the content created, viewed, and/or modified can be packaged and/or summarized, and sent to a personal email address of the customer. Additionally or alternatively, the content and history could be automatically sent to the customer's purchased device if the customer decides to purchase the tablet. A customer may also have an option of demoing certain software for a limited period of the session, with an option of purchasing the software. Any purchased software may be sent to the purchased device, and not the floor model. Another application repository on the floor model may be geared toward an employee rather than a customer. This can allow the employee, for example, to use the same device to ring up the customer's purchase. In some examples, a customer may be able to purchase a new device from a floor model without additional interaction from an employee.

In another example, in an educational setting, an electronic device could start a new session at the beginning of a class period. The session may be associated with content specific to that class period, such as one or more chapters of an electronic textbook or notes associated with the class material. The use of the electronic device during the class period may be limited to the content and applications associated with the session. Additionally, at the end of the session, any notes taken by the user during the class period, along with links to relevant course materials, may be packaged and/or summarized, and sent to the user.

In another example, in a conference or meeting setting, an electronic device could start a session associated with content such as a presentation. The presentation may be interactive, allowing each user to vote in surveys, comment, and/or take notes based on the presentation. Again, at the end of the session, content generated during the session could be sent to the user automatically.

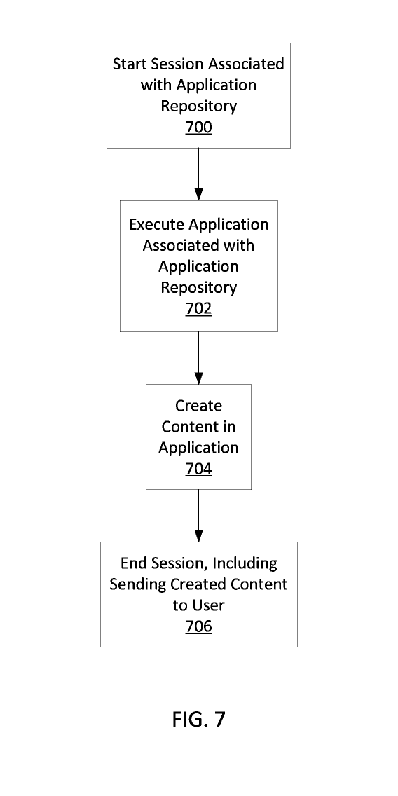

FIG. 7 illustrates an exemplary method of enabling applications during a session associated with an application repository according to examples of the disclosure. A session associated with an application repository may be started (700). Starting the session may include enabling access to one or more applications associated with the application repository and/or disabling access to one or more applications not associated with the application repository. Additionally, pre-existing content may be associated with the session, and access to such content may enabled while disabling access to any other pre-existing content. Starting the session may further include displaying user interface objects, such as icons, associated with some or all of the applications and/or content associated with the session.

An application associated with the application repository may be executed (702), and content may be created in the application (704). Creation of content may include the creation of text, images, spreadsheets, databases, presentations, sounds, and videos, among other possibilities. Creation may also include the modification of pre-existing content. The creation of content may include the examples discussed above and many other possibilities, such as completing answers to an educational problem set, voting in a survey, achieving scores in a game, commenting on a presentation, taking notes in class, creating a history of visited web pages, and creating a log of applications used and/or content viewed/created, among many other possibilities.

The session may be ended, including sending some or all of the created content to a user (706). Ending the session may include disabling access to all applications, and allowing a user to start an additional session. In some examples, ending the session may include enabling access to all applications. In some examples, ending the session may include shutting down the device.

In some examples, the content may be sent to a user based on contact information of the user. The contact information of the user may be stored before the start of the session, or it may be input by the user during the session or at the end of the session. In some examples, the contact information of the user may be automatically generated. For example, if a user has purchased a new device during the session, the content may be sent to contact information associated with the new device. In such a case, the user would not have to input contact information. Sending some or all of the created content may include merely sending links to some or all of the content on a remote device.

In some examples, creating content may include creating a summary of activity during the session and sending the content may include sending the summary of activity. A summary of activity may include additional created content as discussed above, such as notes taken. In some examples, the summary of activity may include titles of content viewed and/or modified, including links to the content and/or short descriptions of the content.

The examples discussed above can be implemented in one or more Application Programming Interfaces (APIs). An API is an interface implemented by a program code component or hardware component (hereinafter “API-implementing component”) that allows a different program code component or hardware component (hereinafter “API-calling component”) to access and use one or more functions, methods, procedures, data structures, classes, and/or other services provided by the API-implementing component. An API can define one or more parameters that are passed between the API-calling component and the API-implementing component.

The above-described features can be implemented as part of an application program interface (API) that can allow it to be incorporated into different applications (e.g., spreadsheet apps) utilizing touch input as an input mechanism. An API can allow a developer of an API-calling component (which may be a third party developer) to leverage specified features, such as those described above, provided by an API-implementing component. There may be one API-calling component or there may be more than one such component. An API can be a source code interface that a computer system or program library provides in order to support requests for services from an application. An operating system (OS) can have multiple APIs to allow applications running on the OS to call one or more of those APIs, and a service (such as a program library) can have multiple APIs to allow an application that uses the service to call one or more of those APIs. An API can be specified in terms of a programming language that can be interpreted or compiled when an application is built.

In some examples, the API-implementing component may provide more than one API, each providing a different view of the functionality implemented by the API-implementing component, or with different aspects that access different aspects of the functionality implemented by the API-implementing component. For example, one API of an API-implementing component can provide a first set of functions and can be exposed to third party developers, and another API of the API-implementing component can be hidden (not exposed) and provide a subset of the first set of functions and also provide another set of functions, such as testing or debugging functions which are not in the first set of functions. In other examples the API-implementing component may itself call one or more other components via an underlying API and thus be both an API-calling component and an API-implementing component.

An API defines the language and parameters that API-calling components use when accessing and using specified features of the API-implementing component. For example, an API-calling component accesses the specified features of the API-implementing component through one or more API calls or invocations (embodied for example by function or method calls) exposed by the API and passes data and control information using parameters via the API calls or invocations. The API-implementing component may return a value through the API in response to an API call from an API-calling component. While the API defines the syntax and result of an API call (e.g., how to invoke the API call and what the API call does), the API may not reveal how the API call accomplishes the function specified by the API call. Various API calls are transferred via the one or more application programming interfaces between the calling (API-calling component) and an API-implementing component. Transferring the API calls may include issuing, initiating, invoking, calling, receiving, returning, or responding to the function calls or messages; in other words, transferring can describe actions by either of the API-calling component or the API-implementing component. The function calls or other invocations of the API may send or receive one or more parameters through a parameter list or other structure. A parameter can be a constant, key, data structure, object, object class, variable, data type, pointer, array, list or a pointer to a function or method or another way to reference a data or other item to be passed via the API.

Furthermore, data types or classes may be provided by the API and implemented by the API-implementing component. Thus, the API-calling component may declare variables, use pointers to, use or instantiate constant values of such types or classes by using definitions provided in the API.

Generally, an API can be used to access a service or data provided by the API-implementing component or to initiate performance of an operation or computation provided by the API-implementing component. By way of example, the API-implementing component and the API-calling component may each be any one of an operating system, a library, a device driver, an API, an application program, or other module (it should be understood that the API-implementing component and the API-calling component may be the same or different type of module from each other). API-implementing components may in some cases be embodied at least in part in firmware, microcode, or other hardware logic. In some examples, an API may allow a client program to use the services provided by a Software Development Kit (SDK) library. In other examples an application or other client program may use an API provided by an Application Framework. In these examples the application or client program may incorporate calls to functions or methods provided by the SDK and provided by the API or use data types or objects defined in the SDK and provided by the API. An Application Framework may in these examples provide a main event loop for a program that responds to various events defined by the Framework. The API allows the application to specify the events and the responses to the events using the Application Framework. In some implementations, an API call can report to an application the capabilities or state of a hardware device, including those related to aspects such as input capabilities and state, output capabilities and state, processing capability, power state, storage capacity and state, communications capability, etc., and the API may be implemented in part by firmware, microcode, or other low level logic that executes in part on the hardware component.

The API-calling component may be a local component (i.e., on the same data processing system as the API-implementing component) or a remote component (i.e., on a different data processing system from the API-implementing component) that communicates with the API-implementing component through the API over a network. It should be understood that an API-implementing component may also act as an API-calling component (i.e., it may make API calls to an API exposed by a different API-implementing component) and an API-calling component may also act as an API-implementing component by implementing an API that is exposed to a different API-calling component.

The API may allow multiple API-calling components written in different programming languages to communicate with the API-implementing component (thus the API may include features for translating calls and returns between the API-implementing component and the API-calling component); however the API may be implemented in terms of a specific programming language. An API-calling component can, in one example, call APIs from different providers such as a set of APIs from an OS provider and another set of APIs from a plug-in provider and another set of APIs from another provider (e.g. the provider of a software library) or creator of the another set of APIs.

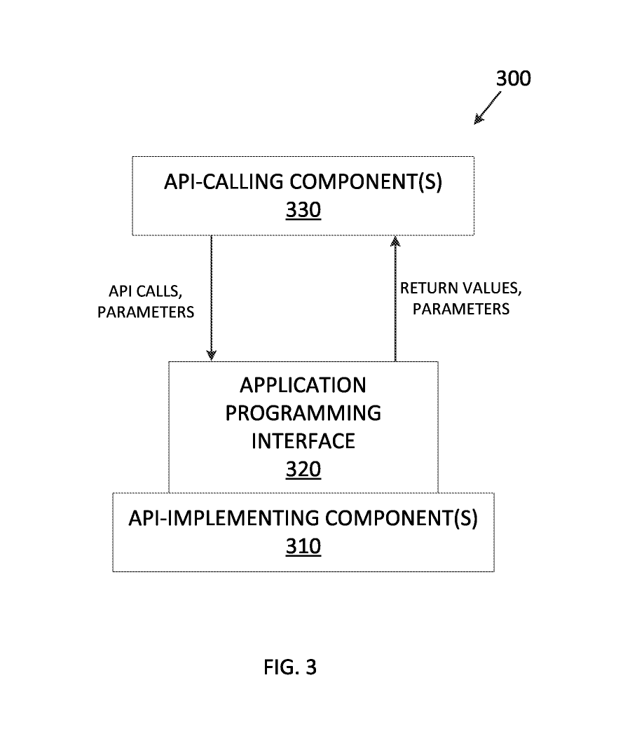

FIG. 3 is a block diagram illustrating an exemplary API architecture, which may be used in some examples of the disclosure. As shown in FIG. 3, the API architecture 300 includes the API-implementing component 310 (e.g., an operating system, a library, a device driver, an API, an application program, software or other module) that implements the API 320. The API 320 specifies one or more functions, methods, classes, objects, protocols, data structures, formats and/or other features of the API-implementing component that may be used by the API-calling component 330. The API 320 can specify at least one calling convention that specifies how a function in the API-implementing component receives parameters from the API-calling component and how the function returns a result to the API-calling component. The API-calling component 330 (e.g., an operating system, a library, a device driver, an API, an application program, software or other module), makes API calls through the API 320 to access and use the features of the API-implementing component 310 that are specified by the API 320. The API-implementing component 310 may return a value through the API 320 to the API-calling component 330 in response to an API call.

It will be appreciated that the API-implementing component 310 may include additional functions, methods, classes, data structures, and/or other features that are not specified through the API 320 and are not available to the API-calling component 330. It should be understood that the API-calling component 330 may be on the same system as the API-implementing component 310 or may be located remotely and accesses the API-implementing component 310 using the API 320 over a network. While FIG. 3 illustrates a single API-calling component 330 interacting with the API 320, it should be understood that other API-calling components, which may be written in different languages (or the same language) than the API-calling component 330, may use the API 320.

The API-implementing component 310, the API 320, and the API-calling component 330 may be stored in a non-transitory machine-readable storage medium, which includes any mechanism for storing information in a form readable by a machine (e.g., a computer or other data processing system). For example, a machine-readable medium includes magnetic disks, optical disks, random access memory; read only memory, flash memory devices, etc.

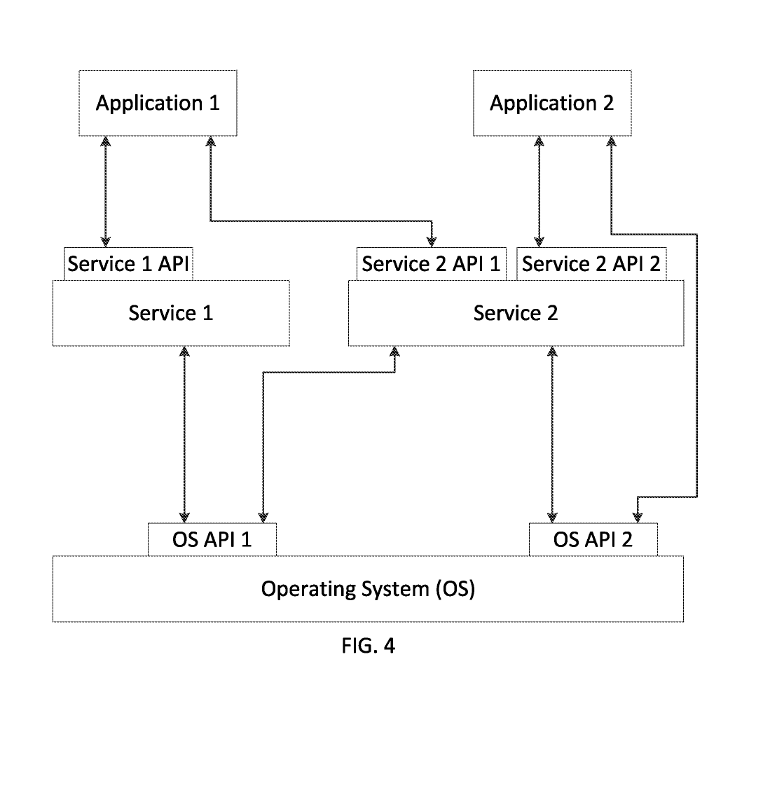

In the exemplary software stack shown in FIG. 4, applications can make calls to Services A or B using several Service APIs and to Operating System (OS) using several OS APIs. Services A and B can make calls to OS using several OS APIs.

Note that the Service 2 has two APIs, one of which (Service 2 API 1) receives calls from and returns values to Application 1 and the other (Service 2 API 2) receives calls from and returns values to Application 2. Service 1 (which can be, for example, a software library) makes calls to and receives returned values from OS API 1, and Service 2 (which can be, for example, a software library) makes calls to and receives returned values from both OS API 1 and OS API 2. Application 2 makes calls to and receives returned values from OS API 2.

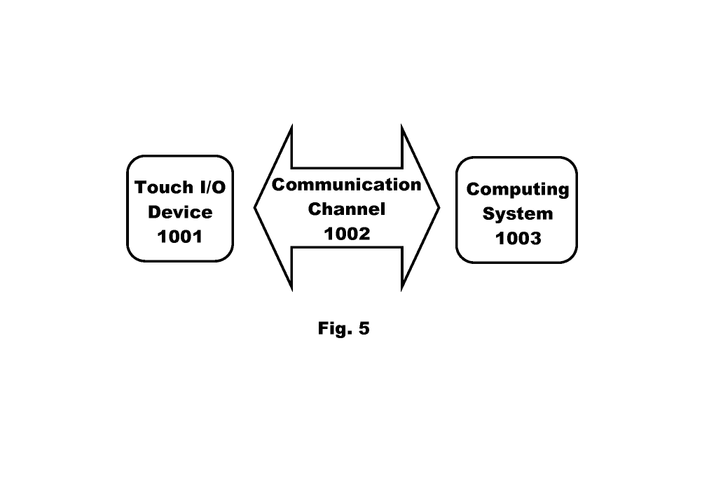

FIG. 5 is a block diagram illustrating exemplary interactions between the touch screen and the other components of the device. Described examples may include touch I/O device 1001 that can receive touch input for interacting with computing system 1003 via wired or wireless communication channel 1002. Touch I/O device 1001 may be used to provide user input to computing system 1003 in lieu of or in combination with other input devices such as a keyboard, mouse, etc. One or more touch I/O devices 1001 may be used for providing user input to computing system 1003. Touch I/O device 1001 may be an integral part of computing system 1003 (e.g., touch screen on a smartphone or a tablet PC) or may be separate from computing system 1003.

Touch I/O device 1001 may include a touch sensitive panel which is wholly or partially transparent, semitransparent, non-transparent, opaque or any combination thereof. Touch I/O device 1001 may be embodied as a touch screen, touch pad, a touch screen functioning as a touch pad (e.g., a touch screen replacing the touchpad of a laptop), a touch screen or touchpad combined or incorporated with any other input device (e.g., a touch screen or touchpad disposed on a keyboard) or any multi-dimensional object having a touch sensitive surface for receiving touch input.

In one example, touch I/O device 1001 embodied as a touch screen may include a transparent and/or semitransparent touch sensitive panel partially or wholly positioned over at least a portion of a display. According to this example, touch I/O device 1001 functions to display graphical data transmitted from computing system 1003 (and/or another source) and also functions to receive user input. In other examples, touch I/O device 1001 may be embodied as an integrated touch screen where touch sensitive components/devices are integral with display components/devices. In still other examples a touch screen may be used as a supplemental or additional display screen for displaying supplemental or the same graphical data as a primary display and to receive touch input.

Touch I/O device 1001 may be configured to detect the location of one or more touches or near touches on device 1001 based on capacitive, resistive, optical, acoustic, inductive, mechanical, chemical measurements, or any phenomena that can be measured with respect to the occurrences of the one or more touches or near touches in proximity to device 1001. Software, hardware, firmware or any combination thereof may be used to process the measurements of the detected touches to identify and track one or more gestures. A gesture may correspond to stationary or non-stationary, single or multiple, touches or near touches on touch I/O device 1001. A gesture may be performed by moving one or more fingers or other objects in a particular manner on touch I/O device 1001 such as tapping, pressing, rocking, scrubbing, twisting, changing orientation, pressing with varying pressure and the like at essentially the same time, contiguously, or consecutively. A gesture may be characterized by, but is not limited to a pinching, sliding, swiping, rotating, flexing, dragging, or tapping motion between or with any other finger or fingers. A single gesture may be performed with one or more hands, by one or more users, or any combination thereof.

Computing system 1003 may drive a display with graphical data to display a graphical user interface (GUI). The GUI may be configured to receive touch input via touch I/O device 1001. Embodied as a touch screen, touch I/O device 1001 may display the GUI. Alternatively, the GUI may be displayed on a display separate from touch I/O device 1001. The GUI may include graphical elements displayed at particular locations within the interface. Graphical elements may include but are not limited to a variety of displayed virtual input devices including virtual scroll wheels, a virtual keyboard, virtual knobs, virtual buttons, any virtual UI, and the like. A user may perform gestures at one or more particular locations on touch I/O device 1001 which may be associated with the graphical elements of the GUI. In other examples, the user may perform gestures at one or more locations that are independent of the locations of graphical elements of the GUI. Gestures performed on touch I/O device 1001 may directly or indirectly manipulate, control, modify, move, actuate, initiate or generally affect graphical elements such as cursors, icons, media files, lists, text, all or portions of images, or the like within the GUI. For instance, in the case of a touch screen, a user may directly interact with a graphical element by performing a gesture over the graphical element on the touch screen. Alternatively, a touch pad generally provides indirect interaction. Gestures may also affect non-displayed GUI elements (e.g., causing user interfaces to appear) or may affect other actions within computing system 1003 (e.g., affect a state or mode of a GUI, application, or operating system). Gestures may or may not be performed on touch I/O device 1001 in conjunction with a displayed cursor. For instance, in the case in which gestures are performed on a touchpad, a cursor (or pointer) may be displayed on a display screen or touch screen and the cursor may be controlled via touch input on the touchpad to interact with graphical objects on the display screen. In other examples in which gestures are performed directly on a touch screen, a user may interact directly with objects on the touch screen, with or without a cursor or pointer being displayed on the touch screen.

Feedback may be provided to the user via communication channel 1002 in response to or based on the touch or near touches on touch I/O device 1001. Feedback may be transmitted optically, mechanically, electrically, olfactory, acoustically, or the like or any combination thereof and in a variable or non-variable manner.

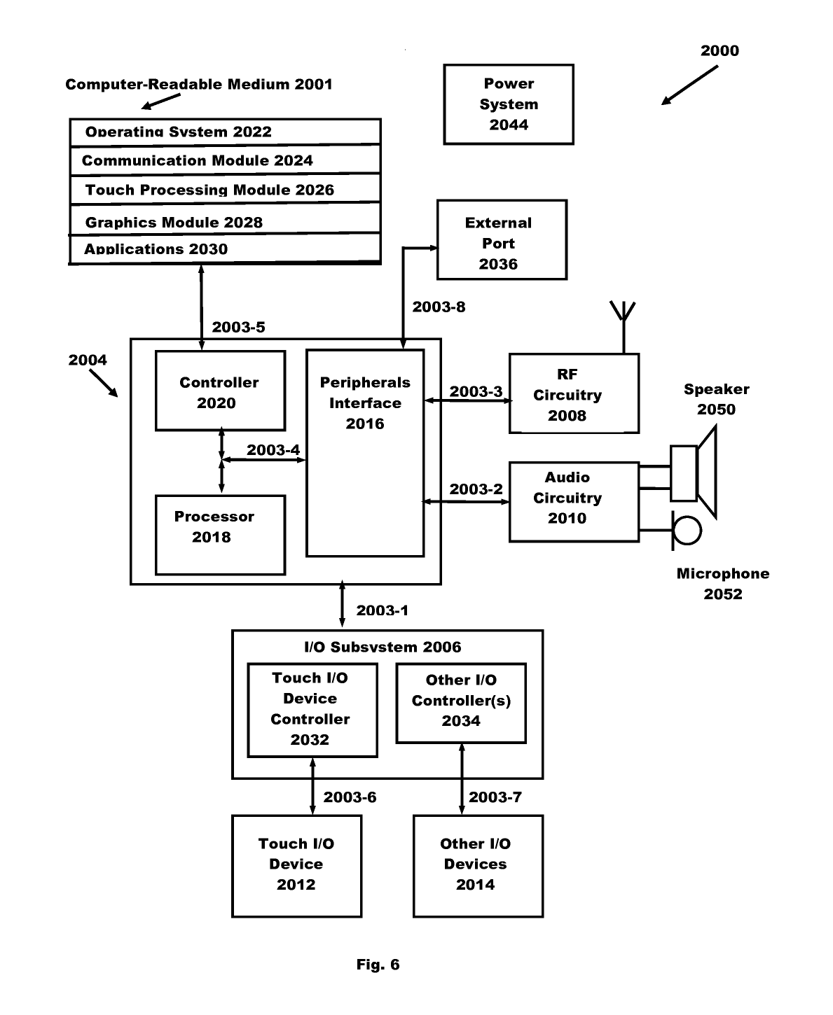

Attention is now directed towards examples of a system architecture that may be embodied within any portable or non-portable device including but not limited to a communication device (e.g. mobile phone, smart phone), a multi-media device (e.g., MP3 player, TV, radio), a portable or handheld computer (e.g., tablet, netbook, laptop), a desktop computer, an All-In-One desktop, a peripheral device, or any other system or device adaptable to the inclusion of system architecture 2000, including combinations of two or more of these types of devices. FIG. 6 is a block diagram of one example of system 2000 that generally includes one or more computer-readable mediums 2001, processing system 2004, I/O subsystem 2006, radio frequency (RF) circuitry 2008, audio circuitry 2010, and gaze detection circuitry 2011. These components may be coupled by one or more communication buses or signal lines 2003.

It should be apparent that the architecture shown in FIG. 6 is only one example architecture of system 2000, and that system 2000 could have more or fewer components than shown, or a different configuration of components. The various components shown in FIG. 8 can be implemented in hardware, software, firmware or any combination thereof, including one or more signal processing and/or application specific integrated circuits.

RF circuitry 2008 is used to send and receive information over a wireless link or network to one or more other devices and includes well-known circuitry for performing this function. RF circuitry 2008 and audio circuitry 2010 are coupled to processing system 2004 via peripherals interface 2016. Interface 2016 includes various known components for establishing and maintaining communication between peripherals and processing system 2004. Audio circuitry 2010 is coupled to audio speaker 2050 and microphone 2052 and includes known circuitry for processing voice signals received from interface 2016 to enable a user to communicate in real-time with other users. In some examples, audio circuitry 2010 includes a headphone jack (not shown).

Peripherals interface 2016 couples the input and output peripherals of the system to processor 2018 and computer-readable medium 2001. One or more processors 2018 communicate with one or more computer-readable mediums 2001 via controller 2020. Computer-readable medium 2001 can be any device or medium that can store code and/or data for use by one or more processors 2018. Medium 2001 can include a memory hierarchy, including but not limited to cache, main memory and secondary memory. The memory hierarchy can be implemented using any combination of RAM (e.g., SRAM, DRAM, DDRAM), ROM, FLASH, magnetic and/or optical storage devices, such as disk drives, magnetic tape, CDs (compact disks) and DVDs (digital video discs). Medium 2001 may also include a transmission medium for carrying information-bearing signals indicative of computer instructions or data (with or without a carrier wave upon which the signals are modulated). For example, the transmission medium may include a communications network, including but not limited to the Internet (also referred to as the World Wide Web), intranet(s), Local Area Networks (LANs), Wide Local Area Networks (WLANs), Storage Area Networks (SANs), Metropolitan Area Networks (MAN) and the like.

One or more processors 2018 run various software components stored in medium 2001 to perform various functions for system 2000. In some examples, the software components include operating system 2022, communication module (or set of instructions) 2024, touch processing module (or set of instructions) 2026, graphics module (or set of instructions) 2028, and one or more applications (or set of instructions) 2030. Each of these modules and above noted applications correspond to a set of instructions for performing one or more functions described above and the methods described in this application (e.g., the computer-implemented methods and other information processing methods described herein). These modules (i.e., sets of instructions) need not be implemented as separate software programs, procedures or modules, and thus various subsets of these modules may be combined or otherwise re-arranged in various examples. In some examples, medium 2001 may store a subset of the modules and data structures identified above. Furthermore, medium 2001 may store additional modules and data structures not described above.

Operating system 2022 includes various procedures, sets of instructions, software components and/or drivers for controlling and managing general system tasks (e.g., memory management, storage device control, power management, etc.) and facilitates communication between various hardware and software components.

Communication module 2024 facilitates communication with other devices over one or more external ports 2036 or via RF circuitry 2008 and includes various software components for handling data received from RF circuitry 2008 and/or external port 2036.

Graphics module 2028 includes various known software components for rendering, animating and displaying graphical objects on a display surface. In examples in which touch I/O device 2012 is a touch sensitive display (e.g., touch screen), graphics module 2028 includes components for rendering, displaying, and animating objects on the touch sensitive display.

One or more applications 2030 can include any applications installed on system 2000, including without limitation, a browser, address book, contact list, email, instant messaging, word processing, keyboard emulation, widgets, JAVA-enabled applications, encryption, digital rights management, voice recognition, voice replication, location determination capability (such as that provided by the global positioning system (GPS)), a music player, etc.

Touch processing module 2026 includes various software components for performing various tasks associated with touch I/O device 2012 including but not limited to receiving and processing touch input received from I/O device 2012 via touch I/O device controller 2032.

I/O subsystem 2006 is coupled to touch I/O device 2012 and one or more other I/O devices 2014 for controlling or performing various functions. Touch I/O device 2012 communicates with processing system 2004 via touch I/O device controller 2032, which includes various components for processing user touch input (e.g., scanning hardware). One or more other input controllers 2034 receives/sends electrical signals from/to other I/O devices 2014. Other I/O devices 2014 may include physical buttons, dials, slider switches, sticks, keyboards, touch pads, additional display screens, or any combination thereof.

If embodied as a touch screen, touch I/O device 2012 displays visual output to the user in a GUI. The visual output may include text, graphics, video, and any combination thereof. Some or all of the visual output may correspond to user-interface objects. Touch I/O device 2012 forms a touch-sensitive surface that accepts touch input from the user. Touch I/O device 2012 and touch screen controller 2032 (along with any associated modules and/or sets of instructions in medium 2001) detects and tracks touches or near touches (and any movement or release of the touch) on touch I/O device 2012 and converts the detected touch input into interaction with graphical objects, such as one or more user-interface objects. In the case in which device 2012 is embodied as a touch screen, the user can directly interact with graphical objects that are displayed on the touch screen. Alternatively, in the case in which device 2012 is embodied as a touch device other than a touch screen (e.g., a touch pad), the user may indirectly interact with graphical objects that are displayed on a separate display screen embodied as I/O device 2014.

Touch I/O device 2012 may be analogous to the multi-touch sensitive surface described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference.

Examples in which touch I/O device 2012 is a touch screen, the touch screen may use LCD (liquid crystal display) technology, LPD (light emitting polymer display) technology, OLED (organic LED), or OEL (organic electro luminescence), although other display technologies may be used in other examples.

Feedback may be provided by touch I/O device 2012 based on the user's touch input as well as a state or states of what is being displayed and/or of the computing system. Feedback may be transmitted optically (e.g., light signal or displayed image), mechanically (e.g., haptic feedback, touch feedback, force feedback, or the like), electrically (e.g., electrical stimulation), olfactory, acoustically (e.g., beep or the like), or the like or any combination thereof and in a variable or non-variable manner.

System 2000 also includes power system 2044 for powering the various hardware components and may include a power management system, one or more power sources, a recharging system, a power failure detection circuit, a power converter or inverter, a power status indicator and any other components typically associated with the generation, management and distribution of power in portable devices.

In some examples, peripherals interface 2016, one or more processors 2018, and memory controller 2020 may be implemented on a single chip, such as processing system 2004. In some other examples, they may be implemented on separate chips.

Examples of the disclosure can be advantageous in providing a user with intuitive and easy-to-use methods for managing access to applications and creating an age-appropriate experience for younger users.

In some examples, a non-transitory computer readable storage medium is disclosed. The medium can have stored therein instructions, which when executed by a mobile device, cause the device perform a method as described by one or more examples herein.

In some examples, a method of a computing device is disclosed. The method can include creating an application repository; associating the application repository with an age level of a user; associating an application with the application repository; and executing the application, including selectively providing content based on the association with the application repository. Additionally or alternatively to one or more of the examples described above, selectively providing content based on the association with the application repository can include selectively providing content based on the age level associated with the application repository. Additionally or alternatively to one or more of the examples described above, the method can further include enabling a limited access mode associated with the application repository; wherein enabling the limited access mode can include enabling access to the application based on the association of the application with the application repository. Additionally or alternatively to one or more of the examples described above, the method can further include determining that an additional application is not associated with the application repository; wherein enabling the limited access mode can further include disabling access to the additional application based on the determination that the additional application is not associated with the application repository. Additionally or alternatively to one or more of the examples described above, the method can further include displaying an indication of the application based on the association of the application with the application repository; and receiving user input on the indication of the application; wherein executing the application can be based on the received user input. Additionally or alternatively to one or more of the examples described above, associating the application with the application repository can be based on receiving user input on the application and the application repository. Additionally or alternatively to one or more of the examples described above, selectively providing content can include setting a difficulty level of the application based on the age level associated with the application repository. Additionally or alternatively to one or more of the examples described above, selectively providing content can include providing an activity prompt based on the age level associated with the application repository. Additionally or alternatively to one or more of the examples described above, providing the activity prompt can be further based on the content of the application. Additionally or alternatively to one or more of the examples described above, the method can further include obtaining a schedule associated with the application repository; and comparing a time to the schedule; wherein executing the application can be based on the comparison of the time to the schedule. Additionally or alternatively to one or more of the examples described above, the method can include receiving user input to the application; and enabling access to an additional application based on the received user input. Additionally or alternatively to one or more of the examples described above, the user input can include completion of a task.

In some examples, an electronic device is disclosed. The electronic device can include a processor to execute instructions; and a memory coupled with the processor to store instructions, which when executed by the processor, cause the processor to perform operations to generate an application programming interface (API) that allows an API-calling component to perform the following operations: creating an application repository; associating the application repository with an age level of a user; associating an application with the application repository; and executing the application, including selectively providing content based on the association with the application repository. Additionally or alternatively to one or more of the examples described above, selectively providing content based on the association with the application repository can include selectively providing content based on the age level associated with the application repository. Additionally or alternatively to one or more of the examples described above, the operations can further include enabling a limited access mode associated with the application repository; wherein enabling the limited access mode can include enabling access to the application based on the association of the application with the application repository. Additionally or alternatively to one or more of the examples described above, the operations can further include determining that an additional application is not associated with the application repository; wherein enabling the limited access mode can further include disabling access to the additional application based on the determination that the additional application is not associated with the application repository. Additionally or alternatively to one or more of the examples described above, the operations can further include displaying an indication of the application based on the association of the application with the application repository; and receiving user input on the indication of the application; wherein executing the application can be based on the received user input. Additionally or alternatively to one or more of the examples described above, associating the application with the application repository can be based on receiving user input on the application and the application repository. Additionally or alternatively to one or more of the examples described above, selectively providing content can include setting a difficulty level of the application based on the age level associated with the application repository. Additionally or alternatively to one or more of the examples described above, selectively providing content can include providing an activity prompt based on the age level associated with the application repository. Additionally or alternatively to one or more of the examples described above, providing the activity prompt can be further based on the content of the application. Additionally or alternatively to one or more of the examples described above, the operations can further include obtaining a schedule associated with the application repository; and comparing a time to the schedule; wherein executing the application can be based on the comparison of the time to the schedule. Additionally or alternatively to one or more of the examples described above, the operations can include receiving user input to the application; and enabling access to an additional application based on the received user input. Additionally or alternatively to one or more of the examples described above, the user input can include completion of a task.

Although the disclosed examples have been fully described with reference to the accompanying drawings, it is to be noted that various changes and modifications will become apparent to those skilled in the art. Such changes and modifications are to be understood as being included within the scope of the disclosed examples as defined by the appended claims.

What is claimed is:

1. A method of a computing device, the method comprising:
creating an application repository;
associating the application repository with an age level of a user;
associating an application with the application repository; and
executing the application, including selectively providing content based on the association with the application repository.

2. The method of claim 1, wherein selectively providing content based on the association with the application repository includes selectively providing content based on the age level associated with the application repository.

3. The method of claim 1, further comprising:
enabling a limited access mode associated with the application repository;
wherein enabling the limited access mode includes enabling access to the application based on the association of the application with the application repository.

4. The method of claim 3, further comprising:
determining that an additional application is not associated with the application repository;
wherein enabling the limited access mode further includes disabling access to the additional application based on the determination that the additional application is not associated with the application repository.

5. The method of claim 1, further comprising:
displaying an indication of the application based on the association of the application with the application repository; and
receiving user input on the indication of the application;
wherein executing the application is based on the received user input.

6. The method of claim 1, wherein associating the application with the application repository is based on receiving user input on the application and the application repository.

7. The method of claim 1, wherein selectively providing content includes setting a difficulty level of the application based on the age level associated with the application repository.

8. The method of claim 1, wherein selectively providing content includes providing an activity prompt based on the age level associated with the application repository.

9. The method of claim 8, wherein providing the activity prompt is further based on the content of the application.

10. The method of claim 1, further comprising:
obtaining a schedule associated with the application repository; and
comparing a time to the schedule;
wherein executing the application is based on the comparison of the time to the schedule.

11. The method of claim 1, further comprising:
receiving user input to the application; and
enabling access to an additional application based on the received user input.

12. The method of claim 11, wherein the user input includes completion of a task.

13. An electronic device, comprising:
a processor to execute instructions; and
a memory coupled with the processor to store instructions, which when executed by the processor, cause the processor to perform operations to generate an application programming interface (API) that allows an API-calling component to perform the following operations:
creating an application repository;
associating the application repository with an age level of a user;
associating an application with the application repository; and
executing the application, including selectively providing content based on the association with the application repository.

14. The electronic device of claim 13, wherein selectively providing content based on the association with the application repository includes selectively providing content based on the age level associated with the application repository.

15. The electronic device of claim 13, the operations further comprising:
enabling a limited access mode associated with the application repository;
wherein enabling the limited access mode includes enabling access to the application based on the association of the application with the application repository.

16. The electronic device of claim 15, the operations further comprising:
determining that an additional application is not associated with the application repository;
wherein enabling the limited access mode further includes disabling access to the additional application based on the determination that the additional application is not associated with the application repository.

17. The electronic device of claim 13, the operations further comprising:
displaying an indication of the application based on the association of the application with the application repository; and
receiving user input on the indication of the application;
wherein executing the application is based on the received user input.

18. The electronic device of claim 13, wherein associating the application with the application repository is based on receiving user input on the application and the application repository.

19. The electronic device of claim 13, wherein selectively providing content includes setting a difficulty level of the application based on the age level associated with the application repository.

20. The electronic device of claim 13, wherein selectively providing content includes providing an activity prompt based on the age level associated with the application repository.

21. The electronic device of claim 20, wherein providing the activity prompt is further based on the content of the application.

22. The electronic device of claim 13, the operations further comprising:
obtaining a schedule associated with the application repository; and
comparing a time to the schedule;
wherein executing the application is based on the comparison of the time to the schedule.

23. The electronic device of claim 13, the operations further comprising:
receiving user input to the application; and
enabling access to an additional application based on the received user input.

24. The method of claim 23, wherein the user input includes completion of a task.
